(19) United States
(12) Patent Application Publication
(10) Pub. No.: US 2012/0301212 A1
(43) Pub. Date: Nov. 29, 2012

(54) Latch Mechanism for Releasably Securing a Seat to a Floor

(75) Inventors: William D. Champ, Mt. Clemens, MI (US); Michele Palomba, Romeo, MI (US)

(73) Assignee: LEAR CORPORATION, Southfield, MI (US)

(21) Appl. No.: 13/574,864

(22) PCT Filed: Apr. 1, 2010
(86) PCT No.: PCT/US10/29611

§ 371 Date: Jul. 24, 2012

(51) Int. Cl. F16B 21/00

(52) U.S. Cl. 403/27; 403/326; 403/409.1; 403/322.4

(57) ABSTRACT

A latch mechanism selectively securing an apparatus, such as a vehicle seat, to a support surface, such as a floor in a vehicle. The latch mechanism includes a housing portion, and a hook that is supported on the housing portion for movement between an engaged position, wherein the apparatus is secured to the support surface, and a disengaged position, wherein the apparatus is not secured to the support surface. A locking cam is supported on the housing portion for movement between a locking position, wherein the hook is positively retained in the engaged position, and an unlocking position, wherein the hook is not positively retained in the engaged position. Lastly, an anti-chuck cam is supported on the housing portion and engages the hook when the hook is in the engaged position to minimize or prevent rattling thereof. A sensor, such as an electrical switch, generates a signal indicating whether the locking cam is in the locking position, wherein the hook is positively retained in the engaged position, or the unlocking position, wherein the hook is not positively retained in the engaged position.

### BACKGROUND OF THE INVENTION

This invention relates in general to systems for releasably securing an apparatus to a support surface. In particular, this invention relates to an improved latch mechanism for releasably securing a seat to a floor, such as in a vehicle.

Virtually all vehicles are provided with one or more seats that are secured to a support surface, such as a floor, for supporting passengers thereon during operation of the vehicle. In many instances, it is desirable to use the vehicle to transport cargo in addition to or in lieu of the passengers. Most vehicles are provided with a cargo space for this purpose. Unfortunately, when the cargo to be transported is relatively large in size, it may not fit conveniently within the cargo space that is provided within the vehicle. To address this, it is known to releasably secure one or more of the seats to the floor of the vehicle. Such releasable securement allows the seat to be either moved to a storage position or be completely removed from the vehicle, thereby significantly increasing the amount of cargo space that is available within the vehicle.

A variety of latch mechanisms are known in the art for releasably securing the seat to the floor of the vehicle. For each movable seat in the vehicle, two of such latch mechanisms are typically provided on the opposite sides of either a front end or a rear end thereof. The two latch mechanisms releasably engage respective inverted U-shaped striker pins that are provided on the floor of the vehicle. When the latch mechanisms are engaged, the associated end of the seat is secured to the floor of the vehicle. When the latch mechanisms are disengaged, the associated end of the seat can be moved out of engagement with the U-shaped striker pins, thereby allowing the seat to be either moved to the storage position or be completely removed from the vehicle, as described above.

The engagement of the latch mechanism with the associated striker pin is an important design consideration. It is known that minor variations can occurs in the size, position, and angularity of the striker pin relative to the components of the latch mechanisms. If, as a result of these minor variations, the latch mechanism engages the striker pin loosely or with an insufficient amount of force, then undesirable rattling of the latch mechanism and the striker pin may occur when the vehicle is operated. If, on the other hand, the latch mechanism engages the associated striker pin tightly or with an excessive amount of force, then an undesirably large amount of force may be required to be exerted to subsequently disengage the latch mechanism. To address these issues, some known latch mechanisms include one or more elastomeric components in the latch mechanism. However, the use of such elastomeric components has been found to be undesirable for several reasons. Thus, it would be desirable to provide an improved latch mechanism for releasably securing a seat to a floor, such as in a vehicle, that addresses these issues without the use of elastomeric components.

### SUMMARY OF THE INVENTION

This invention relates to an improved latch mechanism for releasably securing a seat to a floor, such as in a vehicle. The latch mechanism includes a housing portion, and a hook that is supported on the housing portion for movement between an engaged position, wherein the apparatus is secured to the support surface, and a disengaged position, wherein the apparatus is not secured to the support surface. A locking cam is supported on the housing portion for movement between a locking position, wherein the hook is positively retained in the engaged position, and an unlocking position, wherein the hook is not positively retained in the engaged position. Lastly, an anti-chuck cam is supported on the housing portion and engages the hook when the hook is in the engaged position to minimize or prevent rattling thereof. A sensor, such as an electrical switch, can be provided that generates a signal indicating whether the locking cam is in the locking position, wherein the hook is positively retained in the engaged position, or the unlocking position, wherein the hook is not positively retained in the engaged position.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view, partially broken away, of a portion of a vehicle seat including a latch mechanism in accordance with this invention.

FIG. 2 is an exploded perspective view taken from a first side of one of the latch mechanisms illustrated in FIG. 1.

FIG. 3 is an exploded perspective view taken from an opposite side of the latch mechanism illustrated in FIG. 2.

FIG. 4 is a perspective view of some of the components of the latch mechanism illustrated in FIGS. 2 and 3 shown assembled, wherein the illustrated components of the latch mechanism are shown in a fully engaged condition.

FIG. 5 is an elevational view of the latch mechanism illustrated in FIG. 4 from the opposite side, wherein the illustrated components of the latch mechanism are shown in a fully engaged condition.

FIG. 6 is a perspective view similar to FIG. 4, wherein the release lever and an anti-chuck cam of the latch mechanism are shown in a partially disengaged condition.

FIG. 7 is a perspective view similar to FIG. 6, wherein the release lever and an anti-chuck cam of the latch mechanism are shown in a further disengaged condition.

FIG. 8 is a perspective view similar to FIG. 7, wherein the components of the latch mechanism are shown in a fully disengaged condition.

FIG. 9 is an elevational view of the latch mechanism illustrated in FIG. 8 from the opposite side, wherein the illustrated components of the latch mechanism are shown in a fully disengaged condition.

### DETAILED DESCRIPTION OF THE PREFERRED EMBODIMENT

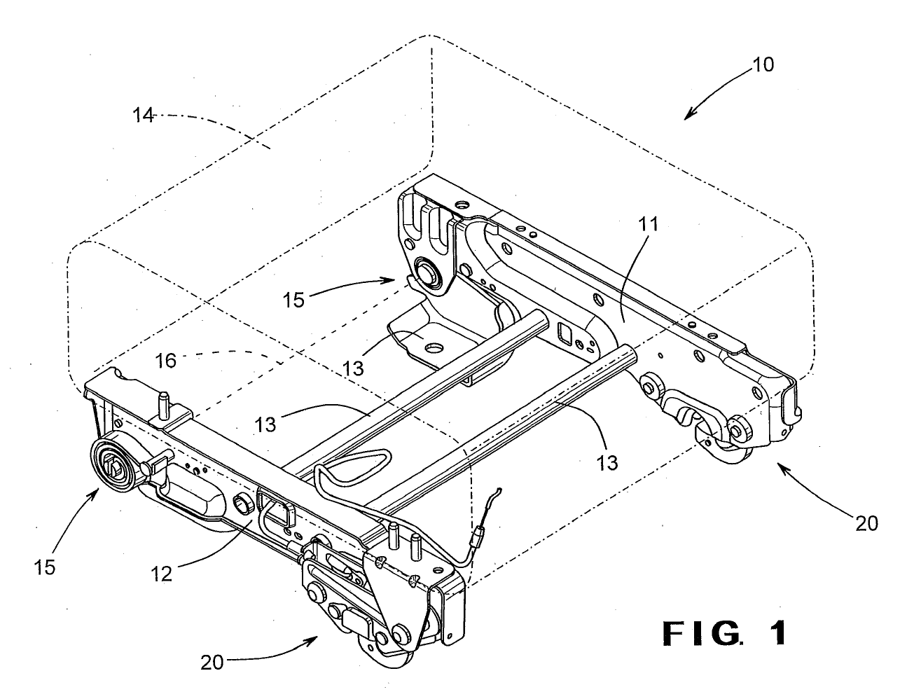

Referring now to the drawings, there is illustrated in FIG. 1, a portion of a vehicle seat, indicated generally at 10, in accordance with this invention. The illustrated vehicle seat 10 is, in large measure, conventional in the art and is intended merely to illustrate one environment in which this invention may be used. Thus, the scope of this invention is not intended to be limited for use with the specific structure for the vehicle seat 10 illustrated in FIG. 1 or with vehicle seats in general. On the contrary, as will become apparent below, this invention may be used in any desired environment for the purposes described below.

The illustrated vehicle seat 10 includes a first side frame member 11 and a second side frame member that are joined together by a plurality of traverse frame members 13. Together, the first side frame member 11, the second side frame member 12, and the traverse frame members 13 define a rigid frame upon which the remaining components of the seat 10 can be supported. For example, a conventional cushion, indicated in dotted lines at 14, can be supported on the frame of the seat 10 in any desired manner. It will be appreciated that the frame of the seat 10 can be embodied as this or any other desired structure.

The illustrated vehicle seat also includes first and second pivot mechanisms, each indicated generally at 15, that are respectively provided on the first and second side frame members 11 and 12 adjacent to a first end thereof. The first and second pivot mechanisms 15 are conventional in the art and are adapted to allow the seat 10 to pivot about an axis, indicated in dotted lines at 16, between deployed and storage positions. In the deployed position, the seat 10 is oriented in such a manner as to allow a person to sit normally on the cushion 14. In the storage position, the seat 10 is oriented in such a manner as to either significantly increase the amount of cargo space that is available for use or to allow the seat 10 to be removed from the vehicle.

The illustrated vehicle seat further includes first and second latch mechanisms, each indicated generally at 20, that are respectively provided on the first and second side frame members 11 and 12 adjacent to a second end thereof. In the illustrated embodiment, the second end of the seat 10 is opposite to the first end where the first and second pivot mechanisms 15 are provided, although such is not necessary. The first and second latch mechanisms 20 are provided to releasably engage respective straight or inverted U-shaped striker pins (not shown) that are provided on the floor of the vehicle. When the first and second latch mechanisms 20 are engaged, the second end of the seat 10 is secured to the floor of the vehicle and, therefore, is locked in the deployed position. When the first and second latch mechanisms 20 are disengaged, the second end of the seat 10 can be moved out of engagement with the U-shaped striker pins, thereby allowing the seat 10 to be either moved to the storage position or be completely removed from the vehicle as described above.

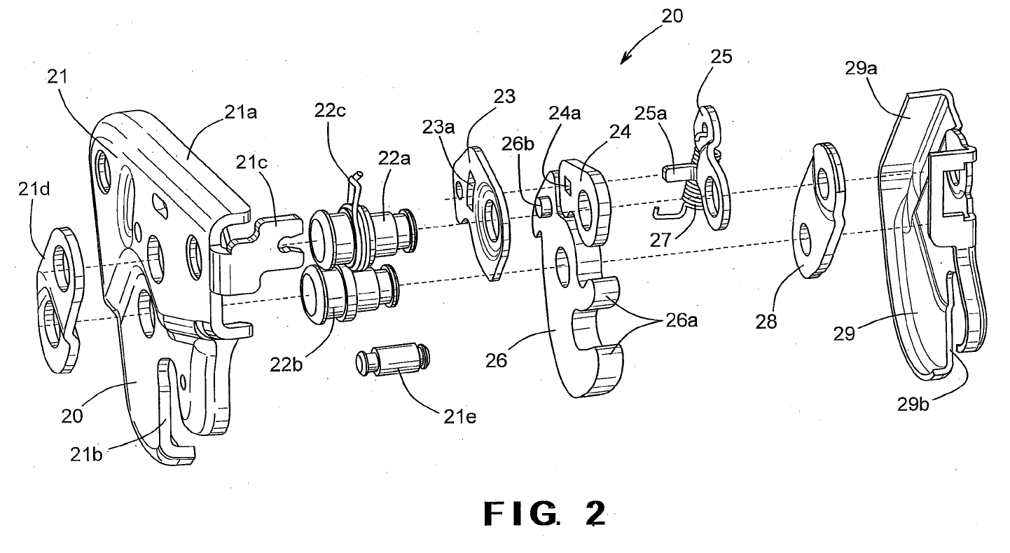

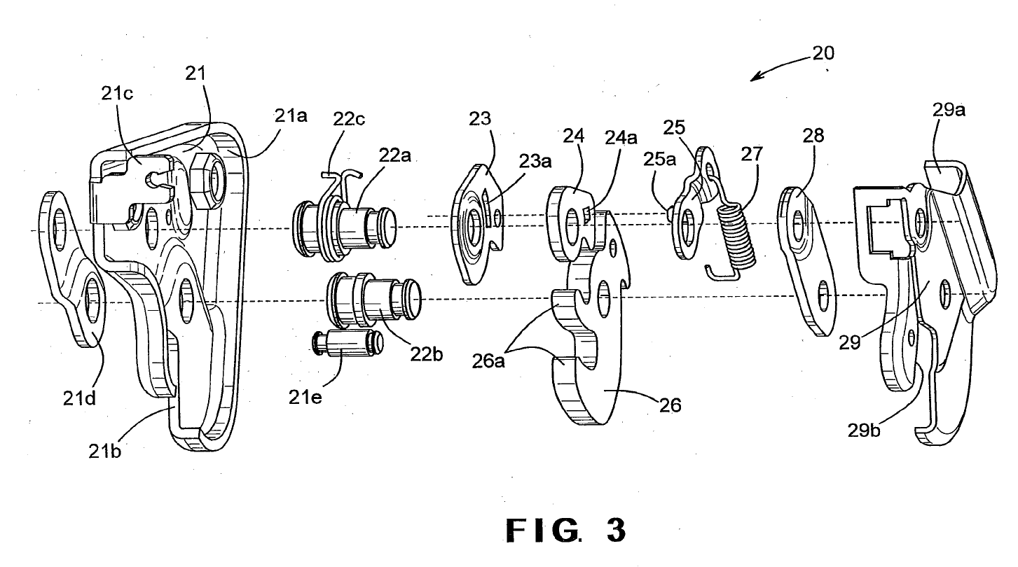

FIGS. 2 and 3 illustrate the components of one of the first and second latch mechanisms 20 illustrated in FIG. 1. It will be appreciated that the first and second latch mechanisms 20 can be formed having the same structure. Alternatively, the first and second latch mechanisms 20 can be formed having mirror image structures if desired. However, this invention contemplates that the first and second latch mechanisms 20 need not have the same or similar structure.

The latch mechanism 20 includes a first housing portion 21 that, in the illustrated embodiment, is rigid and generally flat. If desired, a stiffening lip 21a may extend around some or all of the first housing portion 21. The first housing portion 21 has a recess 21b provided therein, the purpose of which will be explained in detail below. The first housing portion 21 also has a support arm 21c provided thereon, again for a purpose that will be explained below. A first pivot pin 22a and a second pivot pin 22b are supported on the first housing portion 21 and extend laterally therefrom. A torsion spring 22c is supported on the first pivot pin 22a for a purpose that will be explained below.

An anti-chuck cam 23 is supported on the first pivot pin 22a for rotational movement relative to the first housing portion 21. The illustrated anti-chuck cam 23 has a slot 23a formed therein for a purpose that will be explained below. The torsion spring 22c supported on the first pivot pin 22a reacts between the first housing portion 21 and the anti-chuck cam 23. The torsion spring 22c is provided to urge the anti-chuck cam 23 rotationally toward an engaged position, which will be explained in detail below.

An locking cam 24 is also supported on the first pivot pin 22a for rotational movement relative to the first housing portion 21. The illustrated locking cam 24 also has a slot 24a formed therein, again for a purpose that will be explained below. Lastly, a release lever 25 is supported on the first pivot pin 22a for rotational movement relative to the first housing portion 21. The release lever 25 has a tang 25a provided thereon that extends laterally toward the first housing portion 21.

The tang 25a on the release lever 25 extends through both the slot 24a formed through the locking cam 24 and the slot 23a formed through the anti-chuck cam 23. The tang 25a on the release lever 25 defines a circumferential width that is only slightly less than a circumferential width defined by the slot 24a formed through the locking cam 24. Thus, rotational movement of the release lever 25 causes corresponding rotational movement of the locking cam 24 with essentially no lost motion therebetween. However, the circumferential width defined by the tang 25a on the release lever 25 is much smaller than a circumferential width defined by the slot 23a formed through the anti-chuck cam 23. Thus, rotational movement of the release lever 25 causes corresponding rotational movement of the anti-chuck cam 23, but with a significant amount of lost motion therebetween. The purpose for these arrangements will be described below.

A hook 26 is supported on the second pivot pin 22b for rotational movement relative to the first housing portion 21. The illustrated hook 26 has a pair of retaining arms 26a provided thereon. As will be explained in detail below, the hook 26 can be rotated relative to the first housing portion 21 between an engaged position, wherein the retaining arms 26a cooperate with the recess 21b formed in the first housing portion 21 to retain a striker pin (not shown) therein, and a disengaged position, wherein the retaining arms 26a do not cooperate with the recess 21b formed in the first housing portion 21 to retain the striker pin therein. The hook 26 has also a protrusion 26b provided thereon that extends laterally toward the first housing portion 21. The protrusion 26b extends laterally adjacent to an edge of the anti-chuck cam 23 for a purpose that will be explained below. A spring 27 reacts between the hook 26 and the release lever 25 for a reason that will be explained below.

The latch mechanism 20 further includes an internal reinforcement strap 28 that extends between the first and second pivot pins 22a and 22b. The internal reinforcement strap 28 functions to retain the various components of the latch mechanism 20 on the first and second pivot pins 22a and 22b and to provide additional strength to the latch mechanism 20. Lastly, the latch mechanism 20 includes a second housing portion 29 that cooperates with the first housing portion 21 to define an enclosure for the above-described components of the latch mechanism 20. In the illustrated embodiment, the second housing portion 29 is rigid and generally flat. If desired, a stiffening lip 29a may extend around some or all of the second housing portion 29. The second housing portion 29 also has a recess 29b formed therein that cooperates with the recess 21b.

If desired, an external reinforcement strap 21d may be provided on the outer surface of the first housing portion 21. The external reinforcement strap 21d engages the ends of the first and second pivot pins 22a and 22b to provide additional strength to the latch mechanism 20. Additionally, if desired, a rivet 21e may extend laterally between the first and second housing portions 21 and 29. The ends of the rivet 21e can be secured to the first and second housing portions 21 and 29, again to provide additional strength to the latch mechanism 20. The external reinforcement strap 21d and the rivet 21e are optional and form no part of this invention.

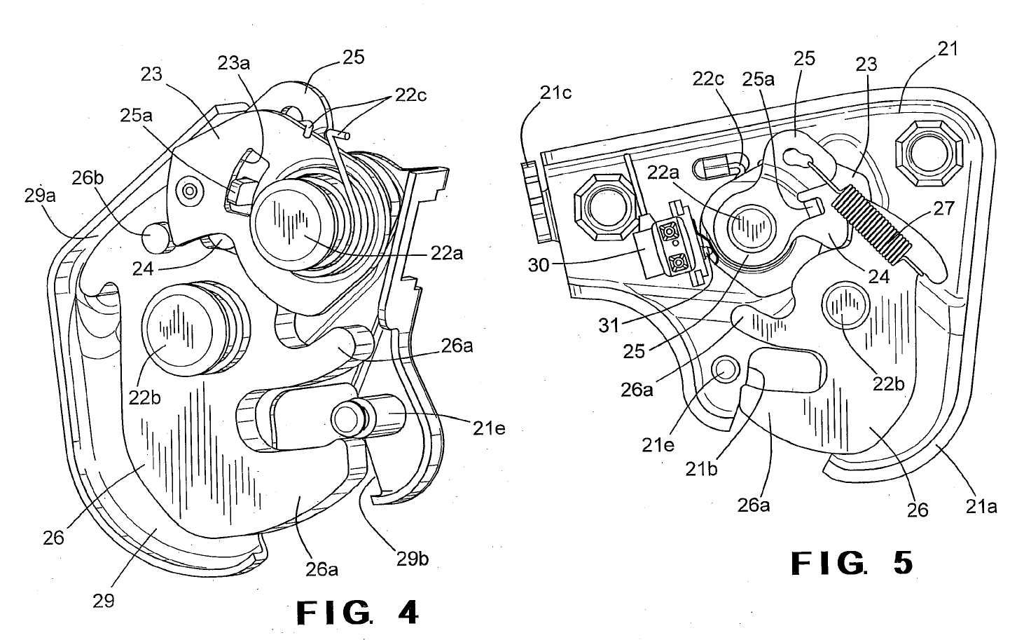

The operation of the latch mechanism 20 will now be described with reference to FIGS. 4 through 9. Initially, as shown in FIGS. 4 and 5, the components of the latch mechanism 20 in a fully engaged condition. In this fully engaged position, the hook 26 is rotated (counterclockwise when viewing FIG. 4, clockwise when viewing FIG. 5) to an engaged position relative to the first housing portion 21 and the second housing portion 29. In this engaged position, the arms 26a of the hook 26 extend across portions of the recesses 21b and 29b respectively provided in the first and second housing portions 21 and 29. As a result, the hook 26 and the first and second housing portions 21 and 29 cooperate to engage and retain a transversely-extending portion of a striker pin (not shown) within the recess 21b. Consequently, the seat 10 is positively connected to the striker pin and, therefore, locked in the deployed position, wherein the seat 10 is oriented in such a manner as to allow a person to sit normally on the cushion 14.

The hook 26 is positively locked in this fully engaged position by means of the locking cam 24. As best shown in FIG. 5, the locking cam 24 is rotated (clockwise when viewing FIG. 5) to a locking position, wherein a portion of the locking cam 24 blocks the hook 26 and thereby prevents the hook 26 from rotating (clockwise when viewing FIG. 4, counterclockwise when viewing FIG. 5) out of the engaged position. The locking cam 24 is urged toward this locking position by means of the spring 27, which reacts between the release lever 25 and the hook 26. As mentioned above, however, the tang 25a on the release lever 25 extends through the slot 24a formed through the locking cam 24 such that rotational movement of the release lever 25 causes corresponding rotational movement of the locking cam 24 with essentially no lost motion therebetween.

Referring back to FIG. 4, it can be seen that when the hook 26 is in its fully engaged position, an edge of the anti-chuck cam 23 engages the laterally extending protrusion 26b provided on the hook 26. The anti-chuck cam 23 is urged toward this engaged position with the protrusion 26b by means of the torsion spring 22c that is supported on the first pivot pin 22a. As mentioned above, the torsion spring 22c reacts between the first housing portion 21 and the anti-chuck cam 23 so as to urge the anti-chuck cam 23 rotationally toward the engaged position. The engagement of the anti-chuck cam 23 with the laterally extending protrusion 26b prevents undesirable rattling of the latch mechanism 20 when the vehicle is operated.

If desired, the latch mechanism 20 may include a sensor that generates a signal indicating whether the locking cam 24 is in the locking position, wherein the hook 26 is positively retained in the engaged position, or the unlocking position, wherein the hook 26 is not positively retained in the engaged position. As shown in FIG. 5, the sensor can be embodied as a switch 30 that generates an electrical signal to a conventional controller (not shown), which signal is indicative of the position of the locking cam 24. The illustrated switch 30 is supported on the second housing portion 29 and includes a plunger 31 that extends into engagement with an edge of the locking cam 24. When the locking cam 24 is rotated (clockwise when viewing FIG. 5) to the locking position as described above, the illustrated plunger 31 is extended outwardly from the switch 30. As a result, the switch 30 generates a first electrical signal to the controller indicating that the hook 26 is positively retained in the engaged position by the locking cam 24, as described above. When the locking cam 24 is rotated (counterclockwise when viewing FIG. 5) from the locking position to an unlocking position (as will be described below), the illustrated plunger 31 is retracted inwardly within the switch 30. As a result, the switch 30 generates a second electrical signal to the controller indicating that the hook 26 is not positively retained in the engaged position by the locking cam 24.

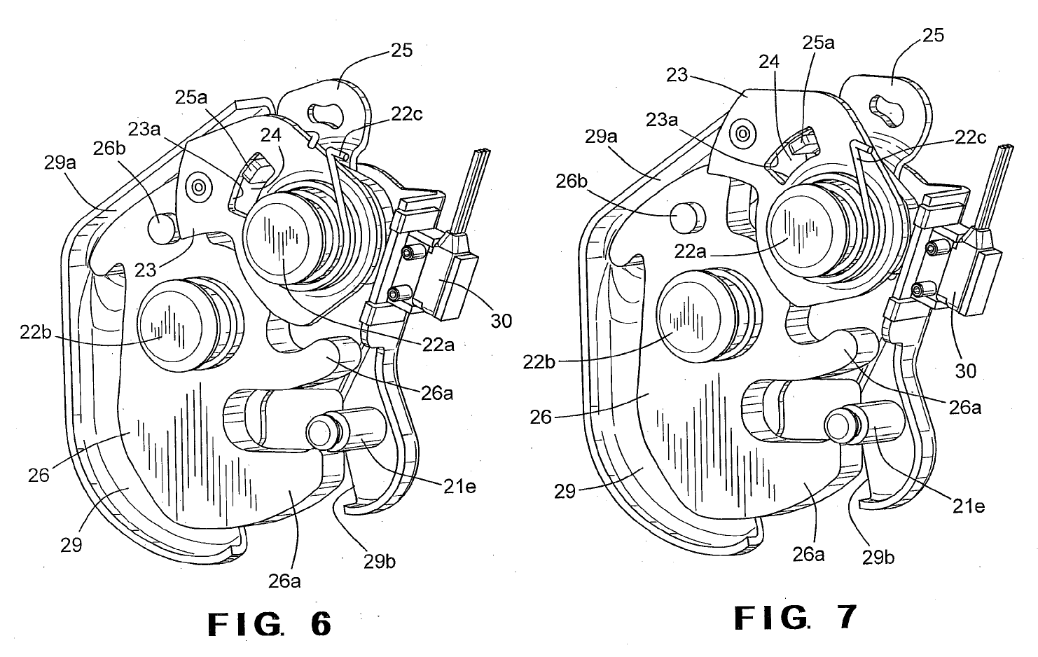

FIG. 6 is a side perspective view similar to FIG. 5, wherein the release lever 25 and the locking cam 24 of the latch mechanism 20 are shown in a partially disengaged condition. This can be accomplished by rotating the release lever 24 (clockwise when viewing FIG. 6) out of the engaged position described above. Typically, such rotational movement of the release lever 25 is accomplished by means of a conventional manually operable actuating mechanism, such as a lever (not shown), that can be grasped and moved by a person desiring to move the seat 10 from the deployed position to the storage position. Movement of the actuating lever causes corresponding movement of a conventional actuating cable (not shown) that can be supported on the support arm 21c provided on the first housing portion 21. As described above, because the tang 25a on the release lever 25 extends through the slot 24a formed through the locking cam 24 with essentially no lost motion therebetween, rotational movement of the release lever 25 causes corresponding rotational movement of the locking cam 24. As a result, when the release lever 25 begins to rotate as a result of movement of the actuating lever and the actuating cable, the locking cam 24 also begins to rotate (clockwise when viewing FIG. 6) out of the locking position described above to an unlocking position.

Such rotational movement of the release lever 25 and the locking cam 24 continues until the tang 25a on the release lever 25 engages the end of the slot 23a on the anti-chuck cam 23, as shown in FIG. 6. Thereafter, as shown in FIG. 7, further rotational movement of the release lever 25 causes rotation (clockwise when viewing FIG. 6) of the anti-chuck cam 23. As a result, the anti-chuck cam 23 is rotated out of engagement with the protrusion 26b provided on the hook 26.

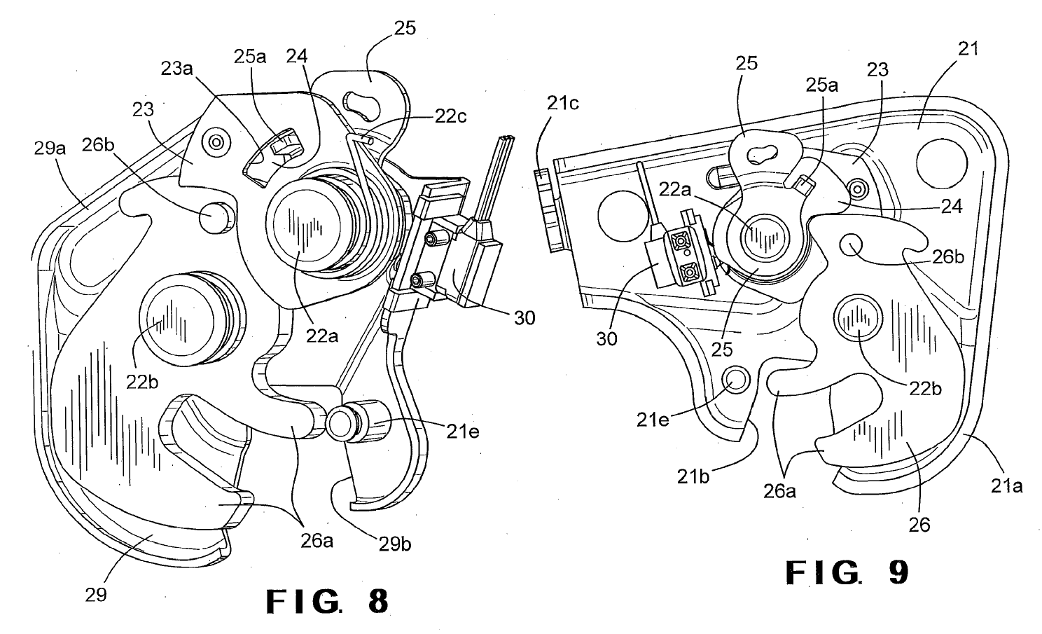

These rotational movements of the release lever 25, the locking cam 24, and the anti-chuck cam 23 are continued until the locking cam 24 is moved completely out of the locking position described above, as shown in FIGS. 8 and 9. When this occurs, the spring 27 causes the hook 26 to rotate (clockwise when viewing FIG. 8, counterclockwise when viewing FIG. 9) to a disengaged condition. As mentioned above, the spring 27 reacts between the hook 26 and the release lever 25. Thus, when the release lever 26 is rotated (clockwise when viewing FIG. 8, counterclockwise when viewing FIG. 9) as described above, the spring 27 urges the hook 26 to rotate in the same direction to the disengaged position. As a result, the retaining arms 26a of the hook 26 do not cooperate with the recesses 21b and 29b respectively provided in the first and second housing portions 21 and 29 to retain the striker pin therein. Consequently, the seat 10 can be moved from the deployed position to the storage position in a conventional manner.

Prior to returning the seat 10 from the storage position to the deployed position, the latch mechanism 20 is in the fully disengaged position shown in FIGS. 8 and 9. When the seat is moved to the deployed position, the striker pin is moved upwardly within the recesses 21b and 29b respectively provided in the first and second housing portions 21 and 29. As a result, the striker pin engages the upper one of the retaining arms 26a provided on the hook 26, thereby causing the hook 26 to rotate (counterclockwise when viewing FIG. 8, clockwise when viewing FIG. 9) from the disengaged position to the engaged position, wherein the retaining arms 26a of the hook 26 cooperate with the recesses 21b and 29b respectively provided in the first and second housing portions 21 and 29 to retain the striker pin therein. When the hook 26 has been rotated (counterclockwise when viewing FIG. 8, clockwise when viewing FIG. 9) by a sufficient amount, the release lever 25, the locking cam 24, and the anti-chuck cam 23 all snap back to their original locked positions to positively lock the hook 26 in the engaged position.

Thus, it will be appreciated that the anti-chuck cam 23 of this invention eliminates any free play in the components of the latch mechanism 20 when the latch mechanism 20 is in the engaged position. As a result, undesirably rattling and other noises reduced or eliminated. Additionally, it will be appreciated that the components of the latch mechanism 20 (including the housing portions 21 and 29, the anti-chuck cam 23, the locking cam 24, and the hook 25) can all be formed from metallic or similarly rigid materials. Thus, the use of elastomeric materials in the latch mechanism 20 can be avoided.

The principle and mode of operation of this invention have been explained and illustrated in its preferred embodiment. However, it must be understood that this invention may be practiced otherwise than as specifically explained and illustrated without departing from its spirit or scope.

1. A latch mechanism for selectively securing an apparatus to a support surface comprising:
a housing portion;
a hook that is supported on the housing portion for movement between an engaged position, wherein the apparatus is secured to the support surface, and a disengaged position, wherein the apparatus is not secured to the support surface;
a locking cam that is supported on the housing portion for movement between a locking position, wherein the hook is positively retained in the engaged position, and an unlocking position, wherein the hook is not positively retained in the engaged position; and
an anti-chuck cam that is supported on the housing portion and engages the hook when the hook is in the engaged position to minimize or prevent rattling thereof.

2. The latch mechanism defined in claim 1 further including a pivot pin that is connected to the housing portion, and wherein the anti-chuck cam is supported on the pivot pin for rotational movement relative to the housing portion.

3. The latch mechanism defined in claim 2 further including a spring for urging the anti-chuck cam into engagement with the hook.

4. The latch mechanism defined in claim 3 wherein the spring is a torsion spring that is supported on the pivot pin.

5. The latch mechanism defined in claim 1 wherein the hook has a protrusion provided thereon, and wherein the anti-chuck cam engages the protrusion provided on the hook when the hook is in the engaged position.

6. The latch mechanism defined in claim 5 further including a pivot pin that is connected to the housing portion, and wherein the anti-chuck cam is supported on the pivot pin for rotational movement relative to the protrusion provided on the housing portion.

7. The latch mechanism defined in claim 6 further including a spring for urging the anti-chuck cam into engagement with the hook.

8. The latch mechanism defined in claim 7 wherein the spring is a torsion spring that is supported on the pivot pin.

9. The latch mechanism defined in claim 1 further including a release lever that is connected to the locking cam for movement therewith, the release lever adapted to be connected to an actuating mechanism, to move the hook from the engaged position to the disengaged position.

10. The latch mechanism defined in claim 9 wherein the release lever has a tang provided thereon that extends into a slot provided on the locking cam.

11. The latch mechanism defined in claim 10 wherein the tang on the release lever defines a circumferential width that is slightly less than a circumferential width defined by the slot formed through the locking cam.

12. The latch mechanism defined in claim 9 wherein the release lever is also connected to the anti-chuck cam for movement therewith lost motion therebetween.

13. The latch mechanism defined in claim 12 wherein the release lever has a tang provided thereon that extends into a slot provided on the locking cam.

14. The latch mechanism defined in claim 13 wherein the tang on the release lever defines a circumferential width that is slightly less than a circumferential width defined by the slot formed through the locking cam.

15. The latch mechanism defined in claim 14 wherein the tang on the release lever also extends into a slot that is provided on the anti-chuck cam.

16. The latch mechanism defined in claim 15 wherein the tang on the release lever defines a circumferential width that is much smaller than a circumferential width defined by the slot formed through the anti-chuck cam.

17. The latch mechanism defined in claim 1 further including first and second pivot pins that are connected to the housing portion, wherein the anti-chuck cam and the locking cam are supported on the first pivot pin and the hook is supported on the second pivot pin.

18. The latch mechanism defined in claim 17 further including a release lever that is supported on the first pivot pin.

19. The latch mechanism defined in claim 1 further including a sensor that generates a signal indicating whether the locking cam is in the locking position, wherein the hook is positively retained in the engaged position, or the unlocking position, wherein the hook is not positively retained in the engaged position.

20. The latch mechanism defined in claim 19 wherein the sensor is responsive to movement of the locking cam for generating the signal.
